(19) United States
(12) Patent Application Publication
(10) Pub. No.: US 2015/0297317 A1
(43) Pub. Date: Oct. 22, 2015

(54) EXTERNAL IRRIGATION SOLUTION DELIVERY SYSTEM FOR DENTAL HANDPIECE

(71) Applicant: TSUNG-HWA CHEN, NEW TAIPEI CITY (TW)

(72) Inventor: TSUNG-HWA CHEN, NEW TAIPEI CITY (TW)

(21) Appl. No.: 14/688,342

(22) Filed: Apr. 16, 2015

(30) Foreign Application Priority Data
Apr. 16, 2014 (TW) 103113791
Apr. 18, 2014 (TW) 103114117

(51) Int. Cl. A61C 1/00; A61C 17/02

(52) U.S. Cl. CPC A61C 1/0084; A61C 17/0202; A61C 1/0069

(57) ABSTRACT

An external irrigation solution delivery system for dental handpiece is specifically used for choosing the required irrigation solutions, other than the initials from the dental unit, for dental handpiece in operation and also heating the solution if required. The system can contains more than one solution containers; by switching a water flow switcher, the system is able to output different solutions driven by pressurized air in the operation of a dentist.

### CROSS REFERENCE TO RELATED APPLICATIONS

a) The present application is based on, and claims priority from, Republic of China (R.O.C.) application number 103114117, filed Apr. 18, 2014, the disclosure of which is hereby incorporated by reference herein in its entirety.
b) The present application is based on, and claims priority from, Republic of China (R.O.C.) application number 103113791, filed Apr. 16, 2014, the disclosure of which is hereby incorporated by reference herein in its entirety.

### BACKGROUND OF THE INVENTION

1. Field of the Invention

The invention relates to an external irrigation solution delivery system for dental handpiece, which is specifically used for choosing the required irrigation solutions, other than the initials from the dental unit, for dental handpiece in operation and also heating the solution if required.

2. Description of Related Art

Dental handpiece is the collective name for a kind of dentist hand-held instrument, it mainly include handpieces driven by compressed air, such as high speed grinding handpiece, low speed grinding handpiece, drilling handpiece, three-way spray gun and scaler, the handpiece is usually activated for washing by stepping a foot switch of the dental unit for controlling the supply of water and compressed air.

However, the pipeline of water supply system in a dental unit which supply water for the use of dental handpiece can only provide normal water such as purified tap water or distilled water; therefore, during the process of treatment, if a dentist needs to use medicinal/chemical solutions, he or she has to use additional apparatus with different sets of handpiece and control switch for the purpose, which will inevitably extends the time of treatment process and causes inconvenience to both the dentist and patient.

### SUMMARY OF THE INVENTION

The main purpose of present invention is to supply the dental handpiece an external irrigation solution delivery system capable of supplying solution of choice, needed for the treatment procedure, to the dental handpiece, using the same control switch as that for the dental handpiece.

The secondary purpose of the present invention is to provide a preheated solution to the dental handpiece if necessary for the treatment purpose without any additional apparatus to heat the solution.

To achieve the purposes above mentioned, this invention of dental handpiece external irrigation solution delivery system mainly consists of one, two or more solution containers, and the pressure inside the container can be increased through the input of compressed air which is supplied through a dental handpiece connector, so as to force the solution filled inside the container to flow out via tubes connected to the container. In case of more than one container, containing different type of solutions, are attached to the system, the flow of the solutions from the different container to the dental handpiece is controlled through a switch valve, which helps to switch between the solutions from the different containers. The flow rate of the solutions can also be controlled through a flow control valve. Moreover, this devices can also heat the solutions inside the container through a heating device to maintain the solution at the temperature of 45˜65° C. to supply the dental handpiece in the course of operation.

### BRIEF DESCRIPTION OF THE DRAWINGS

FIG. 1 is a section view of the components of the external irrigation solution delivery system for dental handpiece when only one solution container 1 is connected to the system, dental handpiece connector 5 can be connected to a dental handpiece.

FIG. 2 is a section view of the components of the external irrigation solution delivery system for dental handpiece when two solution containers 14 and 15 is connected to the system, dental handpiece connector 5 can be connected to a dental handpiece, the water flow switcher 7 is switched to one side.

FIG. 3 is a section view of the components of the external irrigation solution delivery system for dental handpiece when two solution containers 14 and 15 is connected to the system, dental handpiece connector 5 can be connected to a dental handpiece, the water flow switcher 7 is switched to another side.

FIG. 4 is the schematic diagram of the dental handpiece connector, which contains a solution control valve 2 and an air control valve 3.

FIG. 5 is the schematic diagram of the dental handpiece connector, which contains a solution control valve 2 and an air control valve 3, the solution control valve 2 and the air control valve 3 is set into the valves respectively.

FIG. 6 is the section view of the dental handpiece connector, which displays the detailed convex points and springs structure of the control valves.

FIG. 7 is the section view of the connection between the inlet opening and the outlet opening of air transmission pipe 12A and the connection between the inlet opening and the outlet opening of solution transmission pipe 11A.

FIG. 8 is the section view of the air control valve 3A utilizes the air outlet channel 31A of air switch structure to form a three ends connection with the inlet opening and outlet opening of such air transmission pipe 12A.

FIG. 9 is the section view displays the dental handpiece connector is subject to be modified by changing the position of the air control valve to other selective modes.

FIG. 10 is the section view displays the dental handpiece connector is subject to be modified by changing the position of the air control valve to other selective modes to other selective modes, the control valves are rotated.

FIG. 11 is the section view displays the solution control valve 2A can also switch the connection of two openings of the solution transmission pipe 11A through positioning rotation, or connects to the solution inlet channel 21A.

FIG. 12 is the section view displays the connection of the solution control valve.

FIG. 13 is the section view displays the dental handpiece connector is subject to be modified by changing the position of the solution control valve to other selective modes.

FIG. 14 is the section view displays the dental handpiece connector is subject to be modified to other selective modes by changing the position of the solution control valve to other selective modes, the control valves are rotated.

### DETAILED DESCRIPTION OF THE INVENTION

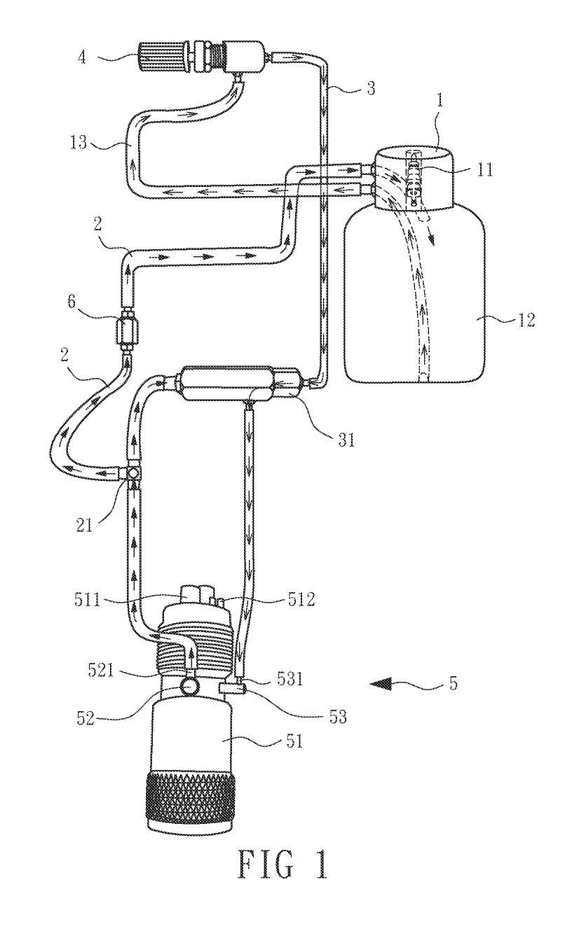

The external irrigation solution delivery system of dental handpiece of present invention can be divided into two cases in practical use, which are one solution container and more than one solution containers, take one solution container as an example of preferred embodiment, please refer to FIG. 1, the external irrigation solution delivery system of dental handpiece of this invention includes a solution supply device 1, an air tube 2, a solution tube 3 and a water flow control valve 4, said solution supply device 1 sets with an air pressure relief valve 11, the solution supply device 1 further has a solution container 12 used for containing purified water, medicinal solutions or other solutions of necessity for the use of dentist in the operation, a tube 13 is set inside said solution supply device 1, the inlet opening of such tube 13 connects to the solution container 12 and extends to the interior bottom of the solution container 12, and the outlet opening of such tube 13 extends to the exterior of said solution supply device 1 and connects to the inlet opening of said water flow control valve 4, the solution tube 3 is connected between the outlet opening of the water flow control valve 4 and a solution outlet attachment 531, and a pneumatic on/off valve 31 is set between the two openings of said solution tube 3, the air tube 3 is connected between an air inlet attachment 521 and solution container 12 of the solution supply device 1, and a three way connector 21 is set between the two openings of said solution tube, through the bifurcation of three way connector, the air tube and such pneumatic on/off valve is connected, besides, there is a one-way valve 6 set at said air tube 2.

Among the structure mentioned above, said solution outlet channel is set at a dental handpiece connector, take a dental hand in patent No. M470674 of the Republic of China for instance, there is a control valve set at the inside of the dental handpiece connector, a solution outlet attachment is set connected to such control valve, by controlling the control valve, it connects a first solution transmission pipe of said dental handpiece with another second solution transmission pipe, or connects the solution outlet attachment with the first solution transmission pipe of the connector and blocks the connection between the first solution transmission pipe and the second solution transmission pipe at the same time. Said dental handpiece and the air inlet attachment 521 are connected to an air supply device respectively, every such air supply device controls the inflow of pressurized air to the dental handpiece or said air inlet attachment 521 by controlling an exterior foot switch respectively, which means it at least needs two foot switches to control the inflow of pressurized air to the dental handpiece and the air inlet attachment 521.

Besides, said air inlet attachment 521 and said solution outlet attachment 531 can be set at a dental handpiece connector, said dental handpiece connector 5 includes a connector body 51, an air control valve 52 and a solution control valve 53, the connector body 51 at least has a solution transmission pipe 512 and an air transmission pipe 511, the inlet opening of said air transmission pipe 511 connects to an air supply device, said air inlet attachment 521 is set at the air control valve 52, by controlling such air control valve 52, the air inlet attachment 521 and the air transmission pipe 511 can be connected or blocked, said solution outlet attachment 531 is set at the solution control valve 53, by controlling solution control valve 53, it connects the inlet opening and outlet opening of solution transmission pipe 512, or connects said solution outlet attachment 531 and the outlet opening of the solution transmission pipe 512 and blocks the connection between the inlet opening and outlet opening of said solution transmission pipe at the same time. The inlet opening of air transmission pipe 511 connects to air supply device, each air supply device only needs a foot switch to control the inflow of pressurized air to the air inlet attachment 521 of dental handpiece connector 5 and traditional dental handpiece connected to the dental handpiece connector 5, which means it only needs a foot switch to control the inflow of pressurized air to traditional handpiece and air inlet attachment 521.

When using the external irrigation solutions delivery system of dental handpiece of present invention, the air supply device controls the inflow of pressurized air to the air inlet attachment through foot switch, or when such air supply device conveys pressurized air from the air inlet attachment 521 to air tube 2 through air transmission pipe of the dental handpiece connector 5, the pressurized air inflows to the solution container 12 of solution supply device 1 through air tube 2, after continuous increase of compressed air inflows into solution container 12, the pressure inside the solution container 12 is therefore arising, under the effect of flowing from high pressure to low pressure, the pressure inside solution container 12 forces the solution contained to output from the tube, and due to the setting of one-way valve 6 at air tube 2, the pressurized air is continuously flow into the solution container 12 and cannot return. Therefore, the pressure inside solution container 12 can only force the tube to output solution to water flow control valve 4, and water flow control valve controls the quantity of solution flow into the solution tube 3, making proper amount of solution flow to pneumatic on/off valve 31 through solution tube 3, since the pressurized air flows to the pneumatic on/off valve 31 through said air tube bifurcated from the three way connector 21 and activates pneumatic on/off valve, making solution flow to solution outlet attachment 531 through pneumatic on/off valve 31, hence achieves the purpose of supplying solution to use for dental handpiece, besides, when the pressure inside solution container 12 is excessive, the solution supply device 1 will release the superfluous pressure through air pressure relief valve 11, so as to maintain the pressure inside solution container 12 in capable of forcing solution to flow out through tube 13.

Moreover, when said air supply device controls the inflow of pressurized air to the dental handpiece through the foot switch, or controls the disconnection between air inlet attachment 521 and air transmission pipe 511 through the air control valve of dental handpiece connector 5, the pressurized air flowing into air tube pipe 2 is thereby blocked, at the meantime, since pneumatic on/off valve 31 stops receiving pressurized air from the air tube, it results in an immediate closure of the pneumatic on/off valve 31 and the solution would be blocked as well, which stops the flowing stream via solution outlet attachment 531, so as to avoid continuous solution supply because it is hard for the internal and external pressure of solution container 12 to reach a prompt balance when the supply of pressurized air stops.

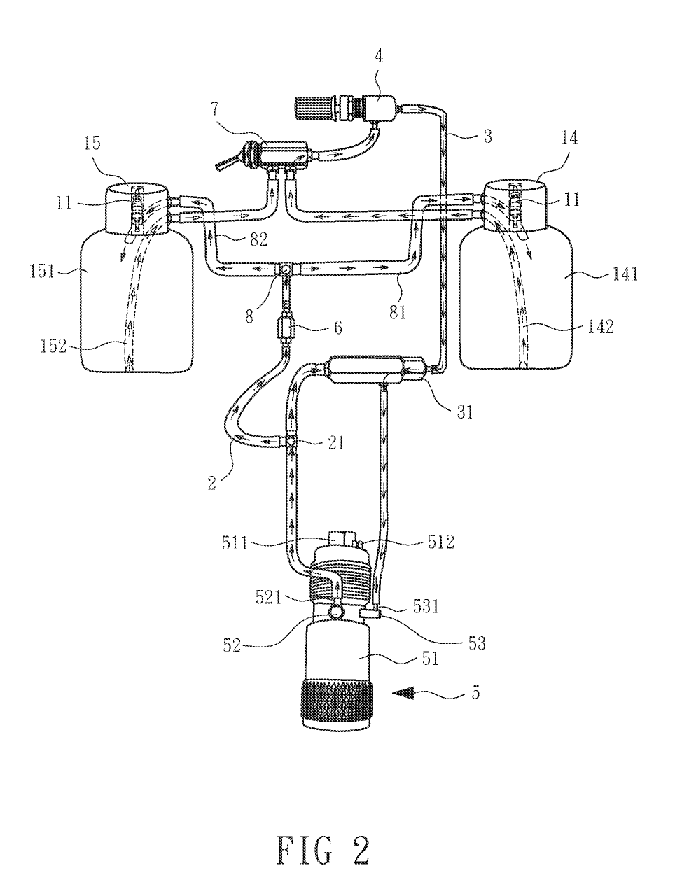

Additionally, when there more than one of solution supply devices involves in the external irrigation solutions delivery system of dental handpiece of present invention, it utilizes flow divider 8 of three way connections or multiple connections to force compressed air to flow to different solution supply devices simultaneously , then in use of a water flow switcher 7, switching of which solution supply device is now connecting to the solution tube 3, so as to switch the solution in use of the dental handpiece; please see FIG. 2˜3, take the following two solution supply devices as examples, the dental handpiece solution supply system includes a first solution supply device 14, a second solution supply device 15, an air tube 2, a solution tube 3, a water flow control valve 4, a water flow switcher 7, a flow divider 8 and a one-way valve 6, both the first solution supply device 14 and the second solution supply device 15 has an air pressure relief valve 11, and said first solution supply device 14 has a first solution container 141 inside, said second solution supply device 15 has a second solution container 151 inside, both the first solution container 141 and such second solution container 151 are optionally contained with purified water, medicinal solutions or other required solutions by the dentist in operation, anyway, the solution contained in said first solution container 141 and said second solution container 151 in the example are different.

The first solution container 141 has a first tube 142 inside, the inlet opening of the first tube 142 connects to such first solution container 141 and extends to the interior bottom of first solution container 141, the outlet opening of such first tube 142 extends to the exterior of the first solution supply device 14 and connects to one of the multiple inlet openings of water flow switcher 7 ; the second solution container 151 has a second tube 152 inside, the inlet opening of the second tube 152 connects to the second solution container 151 and extends to the interior bottom of second solution container 151, the outlet opening of such second tube 152 extends to the exterior of the second solution supply device 15 and connects another of multiple inlet openings of said water flow switcher 7; the solution tube 3 is connected between the outlet opening of said water flow control valve 4 and a solution outlet channel 52, and a pneumatic on/off valve 31 is set between the two openings of said solution tube 3, the air tube 2 is connected between the air inlet attachment 51 and the flow divider 8, there is a three way connector 21 set between the two openings of the air tube, through the bifurcation of three way connector 21, the air tube 2 and pneumatic on/off valve 31 is therefore connected.

The flow divider 8 is set with a first airway part 81 and another second airway part 82, said first airway part 81 connects to the first solution container 141 and said second airway part 82 connects to the second solution container 152, and the water flow control valve 4 is connected to the outlet opening of said water flow switcher 7 and the inlet opening of solution tube 3 correspondingly.

For example, the solution contained in the first solution container 141 is purified water and the second solution container 142 contains a kind of medicinal solution, when the dentist using present system needs purified water in the operation, he or she may utilize said water flow switcher 7 to switch the connection of first tube 142 and the first tube is connected to water flow control valve 4 through the water flow switcher 7; meanwhile, the connection between second tube 152 and water flow switcher 7 is disabled. The convey of the pressurized air from air inlet attachment 51 of dental handpiece connector 5 to air tube 2 is therefore operated, simultaneously making the pressurized air flow into the first solution container 141 from first airway part 81 and into the second solution container 151 from second airway part 82 through the flow divider 8. The pressure inside first solution container 141 and second solution container 151 keeps rising, by utilizing the physical effect of flowing from high pressure to low pressure, the output of purified water contained in first solution container 141 flows from first tube 142 and the output of medicinal solution contained in second solution container 151 flows from second tube 152; in the meantime, since such water flow switcher 7 is connected to first tube 142, the first tube 142 makes the purified water flow into the pneumatic on/off valve 31 at solution tube 3 through water flow switcher 7 and water flow control valve 4, and flow to solution outlet channel 52 through pneumatic on/off valve 31, so as to supply purified water to dental handpiece for use.

Since the water flow switcher 7 cuts off the connection with second tube 152, the medicinal solution contained in second solution container 151 is now unable to flow into the water flow switcher 7, due to the pressure inside second solution container 151 cannot be released along with the outflow of medicinal solution from second tube 152 and together with the setting of one-way valve 6, causing the pressure inside second solution container 151 cannot be released from air tube 2; therefore, when the pressure inside second solution container 151 rises to a certain degree, the air pressure relief valve 11 set in second solution container 151 is capable to release the superfluous pressure for maintaining the pressure inside second solution container then avoid danger.

When the dentist needs to use medicinal solution during the operation, he or she only have to use water flow switcher 7 for cutting off the connection with first tube 142 and connecting to second tube 152 to stop the supply of purified water, and make second tube 152 convey medicinal solution into solution tube 3 through water flow switcher 7 and water flow control valve 4, then flow to the solution outlet channel 52 from said solution tube 3 to acquire medicinal solution to dental handpiece, besides, present dental handpiece solution supply system also includes one or more heating device, the heating device can individually or simultaneously heat one or several solution supply devices 1 or conduct heat preservation, maintaining the solution contained in solution container 12 of solution supply device 1 at the temperature of 45˜65° C. in the operation.

Said dental handpiece connector of the invention can be described in details as follows with figures:

The dental handpiece connector of present invention is used for connecting dental handpiece to an external solution supply device, different solutions are filled inside said solution supply device, those different solutions are possible to be sent to the dental handpiece connector of this invention respectively through multiple solution outlet tubes and transfusion tubes, so that the dentist can switch to select the solution in need from the dental handpiece according to different circumstances during the operation.

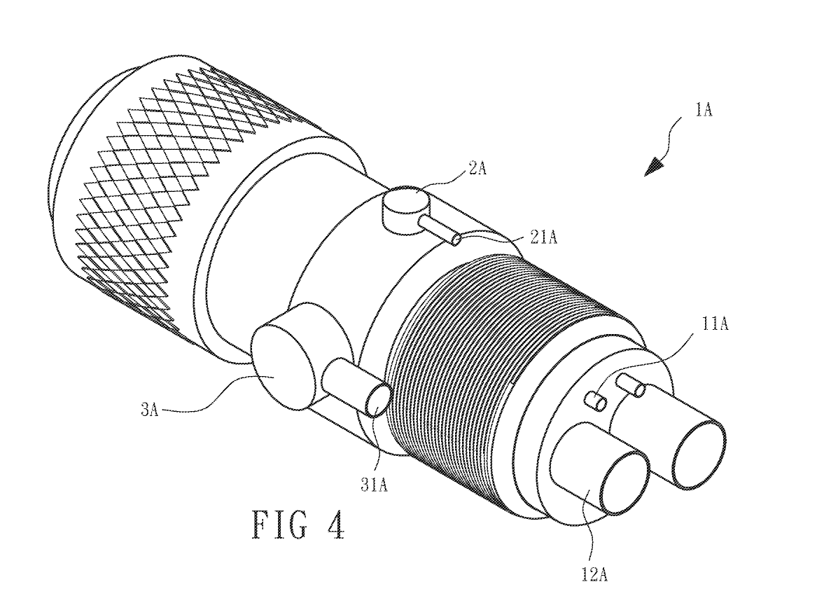

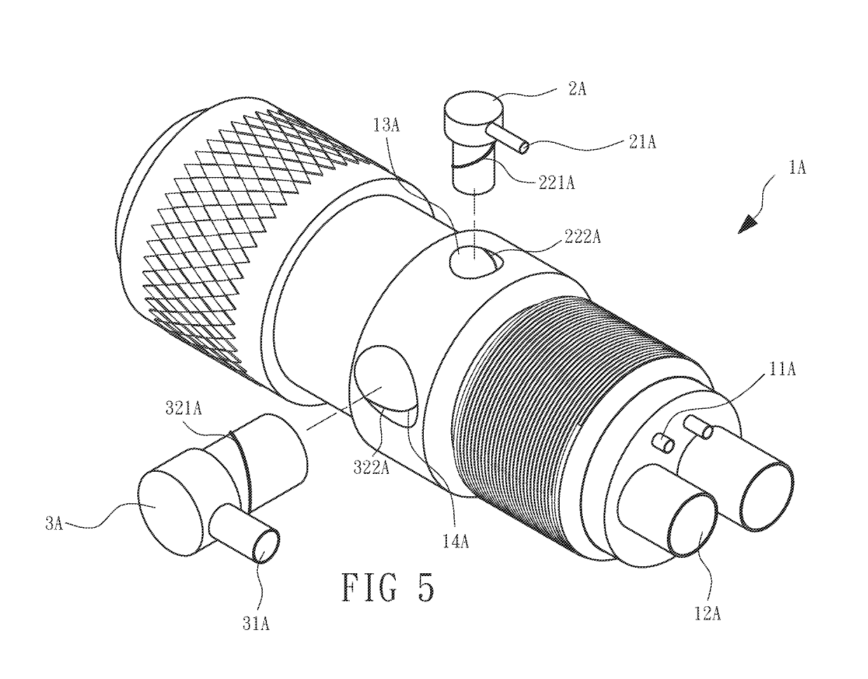

Please refer to FIGS. 4 and 5, the dental handpiece connector of present invention mainly comprises: a connector body 1A, an air control valve 2A and an solution control valve 3A, said connector body at least has a solution transmission pipe 11A and an air transmission pipe 12A, the outlet opening of the air transmission pipe 12A and the outlet opening of the solution transmission pipe 11A is connected to the dental handpiece, the inlet opening of such solution transmission pipe 11A is connected to a solution outlet pipe, the inlet opening of such air transmission pipe 12A is connected to the air inlet pipe supplying pressurized air, said connector body sets with a solution control valve groove 13A which connects to the solution transmission pipe, and an air control valve groove 14A which connects to said air transmission pipe, among them, a solution control valve 2A is set inside the solution control valve groove 13A and an solution inlet channel 21A is set at said solution control valve. The solution inlet channel 21A extends from the interior of solution control valve 2A to its exterior and further connects to the solution supply device through the solution transmission pipe, when such solution inlet channel 21A connects to the outlet opening of solution transmission pipe 11A, the connection between the outlet opening and the inlet opening of said solution transmission pipe will be blocked at the same time. There is an air control valve 3A set inside the air control valve groove 14A and an air outlet channel 31A set at such air control valve 3A, the air outlet channel 31A extends from the interior of air control valve 3 to the exterior of air control valve 3 and connects to air supply system.

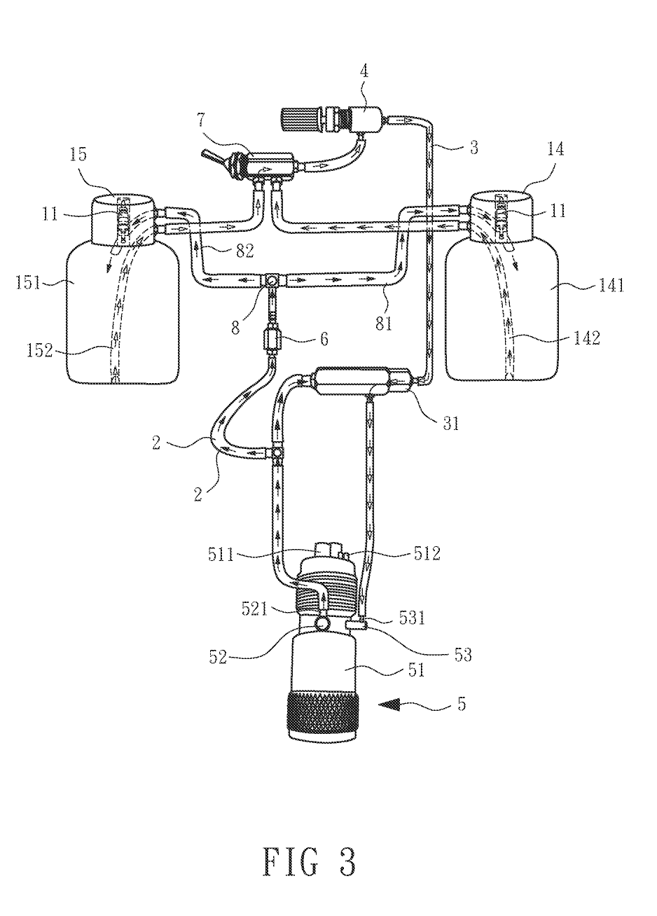

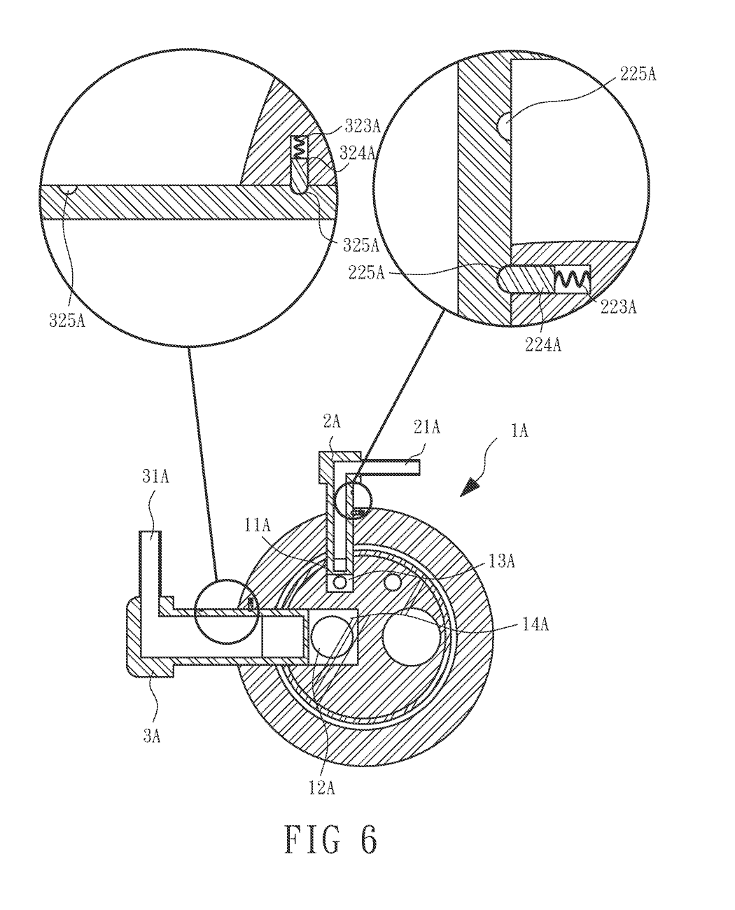

Moreover, there are corresponding solution switch structures set at said solution control valve 2A and said solution control valve groove, and other corresponding air switch structures are also set at the air control valve 3A and the air supply valve groove 14A. As shown in FIG. 6, each solution switch structure comprises of a single screw tooth 221A and a single screw thread 222A, said air solution switch structure comprises of a single screw tooth 321A and a single screw thread 322A, through mutual screwing and rotating of single screw tooth 221A and single screw thread 222A, said solution control valve 2A will switch to the relative positions within the solution control valve groove 13A, and through mutual screwing and rotating single screw tooth 321A and single screw thread 322A, said air control valve 3A will switch to the relative positions within said air control valve groove. Besides as shown in FIG. 3, said solution switch structure may also comprise of a spring 223A, a positioning convex point 224A and several positioning grooves 225A, the spring 223A connects to such positioning convex point 224A, by utilizing the move between said positioning convex point 224A and several positioning grooves 225A and the elasticity of spring 223A, the positioning convex point 224A is therefore snap into one of the several positioning grooves 225A, so as to switch the position of solution control valve 2A in solution control valve groove 13A. Said air switch structure can also comprise of a spring 323A, a positioning convex point 324A and several positioning grooves 325A, by utilizing the elasticity of spring 323A, such positioning convex point 324A may snap into one of the several positioning grooves 325A, so as to switch the position of the air control valve 3A in the air control valve groove 14A.

When using the dental handpiece connector of present invention, if only needs using pressurized air, utilize the control unit to connect the inlet opening and outlet opening of air transmission pipe 12A through air control valve, so as to provide the pressurized air supplied by the air inlet pipe through air transmission pipe to dental handpiece for use; when dental handpiece requires solution, utilize air switch structure to connect the air outlet channel 31A and inlet opening and outlet opening of air transmission pipe 12A through the outlet control valve to form a three ends connection, so that the compressed air can not only be sent to dental handpiece through air transmission pipe 12A, part of air can further reach to the solution supply system through air outlet channel 31A at the same time therefore drives the flow of solution from solution supply system through solution transmission pipe 11A to dental handpiece. In addition, when dentist is in need of other solutions, he or she only needs to control the solution control valve 2A in solution switch structure to connect the solution inlet channel and the outlet opening of solution transmission pipe and block the connection between the inlet opening and the outlet opening of said solution transmission pipe, making the solution flowing through the solution inlet pipe cannot pass to dental handpiece, and the solution connected from solution inlet channel to the solution supply system will be supplied through solution inlet channel 21A to the dental handpiece for use.

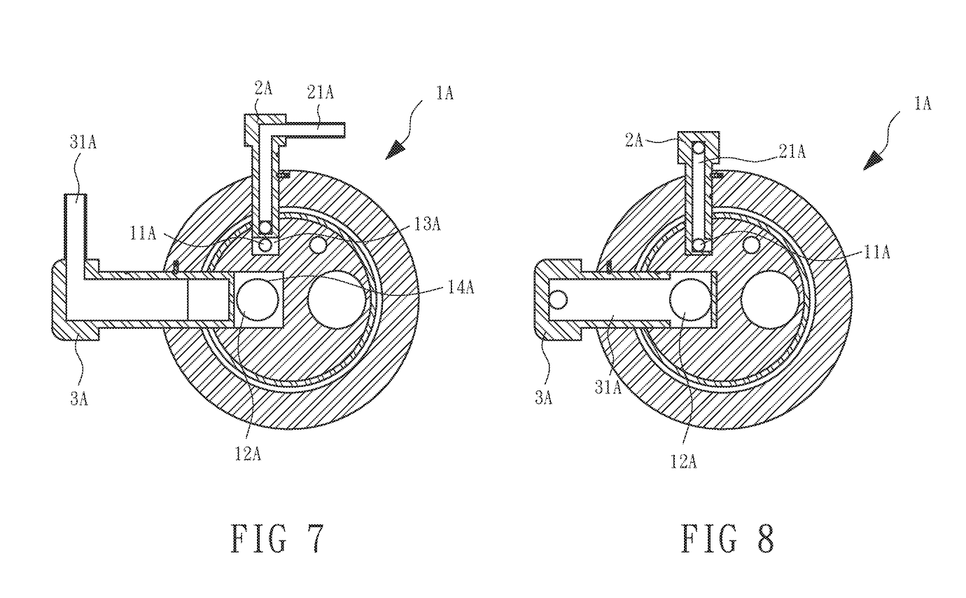

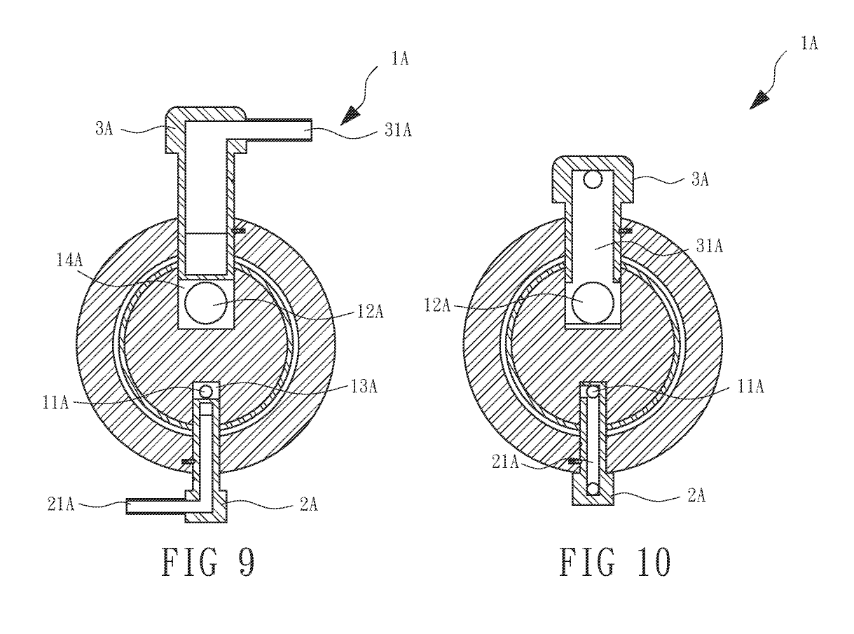

Please refer to FIGS. 7 and 8, which display the sectional view of use status indicating that this invention utilizes control unit to switch the connection between inlet opening and outlet opening of air transmission pipe 12A through air control valve 3A, or the three-way connection formed among solution air outlet channel 31A and the inlet opening and the outlet opening of air transmission pipe 12A. Through solution control valve 2A, it utilizes control unit to switch the connection between the inlet opening and the outlet opening of solution transmission pipe 11A, or the connection between outlet opening of solution transmission pipe 11A and solution inlet channel 21A, among them, FIG. 7 is the schematic diagram for the connection between the inlet opening and the outlet opening of air transmission pipe 12A and the connection between the inlet opening and the outlet opening of solution transmission pipe 11A, it is the schematic diagram indicating that the solution control valve 2A utilizes solution switch structure to move above said solution control valve groove 13A, so as to connect the inlet opening and the outlet opening of the solution transmission pipe, and the air control valve 3A utilizes air switch structure to move above such air control valve groove 14A, so as to connect the inlet opening and outlet opening of air transmission pipe. Moreover, FIG. 8 is the schematic diagram indicating that the air control valve 3A utilizes the air outlet channel 31A of air switch structure to form a three ends connection with the inlet opening and outlet opening of such air transmission pipe 12A, and said solution control valve 2A utilizes solution switch structure to move below such solution control valve groove 13A, so as to connect the solution inlet channel 21A and the outlet opening of said solution transmission pipe 11A. Besides, as shown in FIG. 7˜10, the connector body of dental handpiece connector of this invention is subject to modify to a connector device which makes two to two, two to four, four to two or four to four connection between devices.

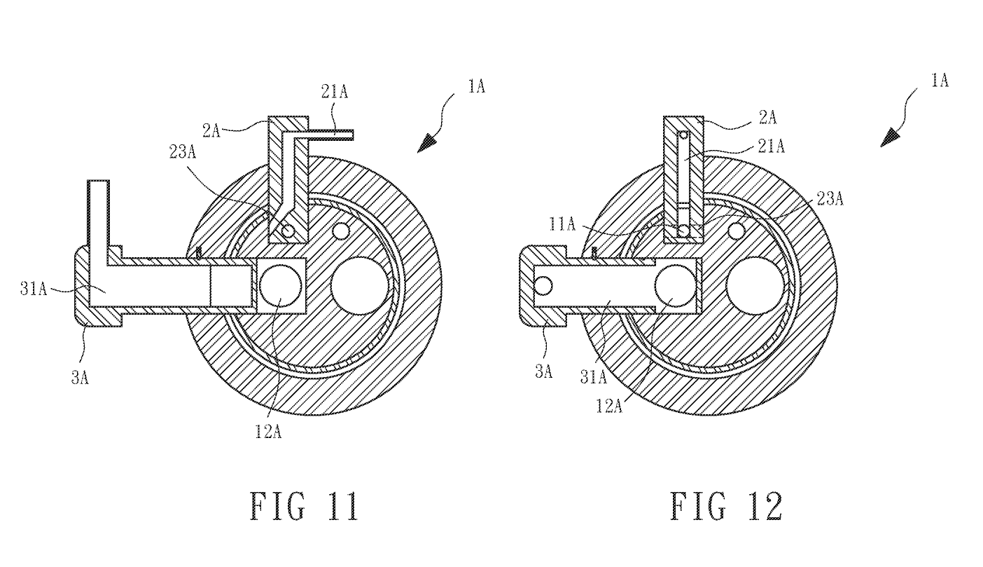

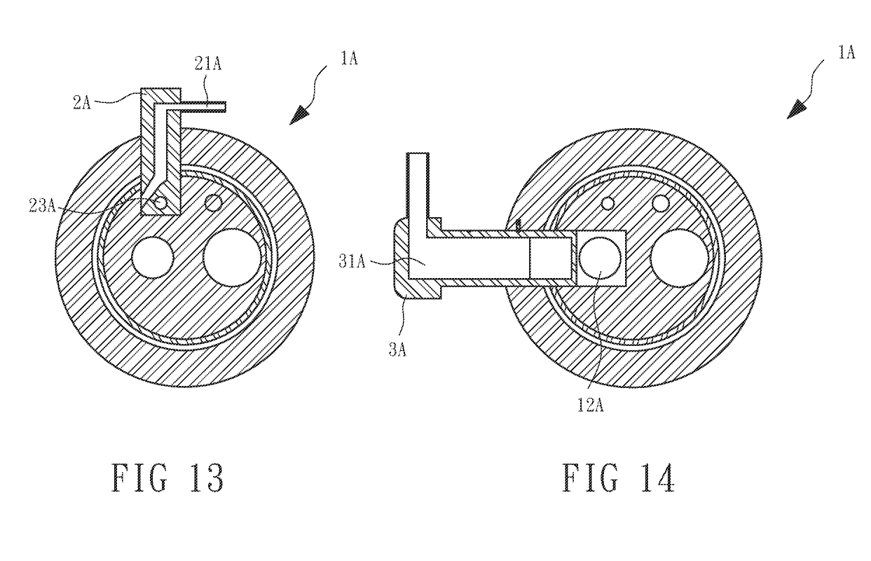

Please see FIGS. 11 and 12, in the dental handpiece connector of present invention, said solution control valve 2A can also switch the connection of two openings of the solution transmission pipe 11A through positioning rotation, or connects the solution inlet channel 21A to said outlet opening of solution transmission pipe 11A, without utilizing solution switch structure to switch the upper or lower position of solution control valve 2A relative to solution control valve groove 13A, it sets solution inlet channel 23A going through solution control valve 2A as solution control valve 2A to connect the front opening and the rear opening of solution transmission pipe 11A, and such solution inlet channel is set parallel to the air inlet channel 21A and not connected to said air inlet channel 21A, when dental handpiece requires solution, said solution inlet channel 23A will connect the front opening and rear opening of solution transmission pipe 11A, providing the solution supplied by the solution inlet pipe through solution transmission pipe 11A and solution inlet channel 23A to the dental handpiece. When needs to switch the solution in use, the dentist only needs to rotate solution control valve 2A to connect the solution inlet channel 21A to the outlet opening of solution transmission pipe 11. Additionally, refer to FIGS. 13 and 14, this invention may also set air control valve 3A or solution control valve 2 independently based on the demand.

Furthermore, it is not necessary to set an air switch structure in the dental handpiece connector of present invention, use said air control valve directly to maintain three ends connection formed by the air outlet channel together with the inlet opening and the outlet opening of said air transmission pipe, it only needs to control a switch on the solution supply system for controlling the access of compressed air to the solution supply system.

In conclusion, comparing present dental handpiece solution supply system with previous systems and technologies, following advantages can be discovered from the present external irrigation solution delivery system for dental handpiece:
1. This invention switches the connection of tube of required solutions through the water flow switcher, which is able to control the use of different necessary solutions from the dental handpiece in operation; therefore, additional apparatus with different sets of medicinal solution is not of necessity.
2. Through the heating device, present invention can preheat the solution in need in the operation without additional manpower for conducting temporary heating, which is effective for saving manpower.

What is claimed is:

1. A dental handpiece external irrigation solution delivery system, comprising:
a solution container for the solution of choice, said solution container set with an air pressure relief valve;
a tube, wherein an inlet opening of said tube is inserted from the cap of the solution container into said solution container reaching the bottom of the solution container;
a water flow control valve set outside the solution container for controlling the flow of the solution from said solution container wherein inlet opening of the water flow control valve is connected to an outlet opening of said tube;
an air tube for transporting pressurized air, wherein an outlet opening of the air tube is bifurcate to have two outlet openings by a three way connector, and a bifurcated opening of the air tube goes into said solution container to supply pressurized air and an extra bifurcated opening of the air tube is connected to a pneumatic on/off valve to control the flow of the solution from the solution container;
a solution tube, which is divided as two parts, one part connects an inlet opening of said solution tube to said pneumatic on/off valve, another part connects the pneumatic on/off valve to an outlet opening of the solution tube; the inlet opening of the solution tube connects to an outlet opening of said water flow control valve; and
when pressurized air goes into the pneumatic on/off valve via the extra bifurcated opening of the air tube, the pneumatic on/off valve is switched to opened, allowing the solution to exit the pneumatic on/off valve. Once the pressurized air is cut off then the pneumatic on/off valve is switched to closed, which blocks the flow of the solution.

2. The dental handpiece external irrigation solution delivery system of claim 1, wherein an inlet opening of the air tube and the outlet opening of the solution tube are attached to a dental handpiece connector.

3. The dental handpiece external irrigation solution delivery system of claim 2, wherein the dental handpiece connector comprising:
a connector body which has a solution inlet attachment and an air outlet attachment;
said air outlet attachment has an air control valve inside the connector body connects to the inlet opening of the air tube, the air control valve controls the outflow or the blockage of pressurized air from the air outlet attachment to the inlet opening of the air tube;
said solution inlet attachment has a solution control valve inside the connector body connects to the outlet opening of the solution tube, the solution control valve controls the inflow of solution from the solution inlet attachment to the outlet opening of the solution tube; and
said solution control valve can block the water flow from the dental unit to the dental handpiece and allow the outflow of solution from the system to the dental handpiece though the connector; the solution control valve can also block the outflow of the solution from the system to the dental handpiece via the connector and allow the water flow from the dental unit to the dental handpiece.

4. The dental handpiece external irrigation solution delivery system of claim 1, further comprising:
a heating device conducts heating to the solution of choice inside said solution container.

5. The dental handpiece external irrigation solution delivery system of claim 1, wherein a one-way valve is set at said air tube.

6. A dental handpiece external irrigation solution delivery system, which supplies single or multiple type of solutions to dental handpiece through a dental handpiece connector, comprising:
two or more solution containers, wherein each of the of the solution container is set with an air pressure relief valve and a tube, the inlet opening of said tube extends into said solution container and reaches the bottom of said solution container;
a water flow switcher is set outside said solution container, wherein said water flow switcher has multiple inlet openings which connect to more than one outlet openings of said tube from the solution containers respectively;
a water flow control valve, wherein an inlet opening of said water flow control valve is connected to an outlet opening of said water flow switcher;
a solution tube, which is divided as two parts, one part connects an inlet opening of said solution tube to a pneumatic on/off valve, another part connects the pneumatic on/off valve to an outlet opening of the solution tube; the inlet opening of the solution tube connects to an outlet opening of said water flow control valve;
a flow divider having multiple connectors which correspondingly connect to each of the solution containers via multiple of the tubes;
an air tube divided as several parts, wherein a multiple-way connector is set on said air tube distributes pressurized air to multiple solution containers by multiple parts of the air tube, an inlet opening of said multiple-way connector is connected to an outlet opening of an one-way valve; the inlet opening of the one-way valve is connected to a three-way connector; said three-way connector has an inlet opening connected to the air inlet opening of said air inlet tube, an outlet opening of the three-way connector is connected to said one-way valve and another outlet opening is connected to a pneumatic on/off valve; the pneumatic on/off valve has an inlet point connected to one part of said solution tube and another inlet point connected to the another outlet opening of the three-way connector, also an outlet point of the pneumatic on/off valve connects to another part of said solution tube together to transport the solution of choice; and
when the pneumatic on/off valve receives pressurized air from the air inlet tube, the pneumatic on/off valve switched to opened and allows the solution to flow via the pneumatic on/off valve, and when the pressurized air flow stops, the pneumatic on/off valve blocks the flow of the solution.

7. The dental handpiece external irrigation solution delivery system of claim 6, wherein said solution tube has an outlet opening which connects to an inlet opening of a dental handpiece connector.

8. The dental handpiece external irrigation solution delivery system of claim 7, wherein said dental handpiece connector further comprises:
a connector body which has a solution inlet attachment and an air outlet attachment;
said air outlet attachment having an air control valve inside the connector body connects to the inlet opening of the air tube, wherein the air control valve controls the outflow or the blockage of pressurized air from the air outlet attachment to the inlet opening of the air tube;
said solution inlet attachment having a solution control valve inside the connector body connects to the outlet opening of the solution tube, wherein the solution control valve controls the inflow of solution from the solution inlet attachment to the outlet opening of the solution tube; and
said solution control valve which can block the water flow from the dental unit to the dental handpiece and allow the outflow of solution from the system to the dental handpiece though the connector; the solution control valve can also block the outflow of the solution from the system to the dental handpiece via the connector and allow the water flow from the dental unit to the dental handpiece.

9. The dental hand piece external irrigation solution delivery system of claim 6, wherein further comprises:
a heating device conducting individually or simultaneously heating to the solution of choice inside said solution containers.
